(19) United States
(12) Patent Application Publication
(10) Pub. No.: US 2022/0034680 A1
(43) Pub. Date: Feb. 3, 2022

(54) Method and system of topological localization in a built environment

(71) Applicants: Teseo S.r.l., Genova (GE) (IT); Università degli Studi di Genova, Genova (IT)

(72) Inventors: Daniel Bertocci, Camogli (GE) (IT); Carola Motolese, Savona (IT); Antonello Scalmato, Genova (IT); Alessandro Sperindè, Genova (IT); Fulvio Mastrogiovanni, Genova (IT); Anotonella Giuni, Genova (IT)

(21) Appl. No.: 17/376,626

(22) Filed: Jul. 15, 2021

(30) Foreign Application Priority Data
Jul. 22, 2020 (IT) 102020000017722

(51) Int. Cl. G01C 21/00; G06N 3/08

(52) U.S. Cl. CPC G01C 21/383; G06N 3/08

(57) ABSTRACT

A system and method of topological localization of a person or an object that is moved by one or more people in a built environment includes at least one sensor for detecting the movement of the person or object in that environment, configured to provide differential data over time; a transmission unit of differential movement information detected by the sensor mechanically coupled to the person or object; a reception unit of the differential movement information transmitted by the transmission unit; and a processing unit configured to perform an evaluation procedure of the differential movement information, which recognizes the presence of a voluntary movement activity as opposed to an involuntary movement, and, in the event of a voluntary movement activity, recognizes a path within the environment by comparing differential movement parameters, using models of execution of voluntary movement activities in a plurality of predefined paths within the same built environment.

### FIELD OF THE INVENTION

The present invention relates to a method and a class of systems for the topological localization of people or objects that are moved by one or more people in a built environment.

### BACKGROUND OF THE INVENTION

Location systems are generally based on wireless communication technologies involving one or more mobile devices and one or more fixed devices. At the current state of the art, the most used technologies are the following, or in any case they are based on similar principles:

Global Positioning System (GPS): It consists of a series of satellites (transmitters in geostationary orbit) that periodically transmit information to mobile receivers on the earth's surface. The receivers calculate their position on the basis of the coordinates of the satellites with respect to a defined reference system, and the accuracy achieved also increases as the number of references to the satellites increases. It is necessary to have at least three satellite references to calculate the position.

Global System for Mobile Communications (GSM): This is a series of location services offered by mobile telephone operators. Their operation is based on the use of the same antenna network that provides the telephony service. The position can be calculated both in the mobile device and by the service provider, since both terrestrial and mobile device antennas can function as transmitters or receivers. There are several parameters used for position calculation, such as signal arrival time, angles of incidence, tri-lateration or multi-lateration of signals or cells to which they belong.

Assisted GPS (AGPS): This is a hybrid technology usually employed in mobile devices that have a GPS receiver. It uses both signals provided by satellites and those provided by mobile phone networks. It is used in two circumstances: when the GPS signal is not sufficient for localization, for example due to the low number of references to satellites, and when the mobile device starts performing the GPS function, i.e. the moment when the device assumes the its position in the mobile phone network to assist the GPS signal.

These technologies and those based on similar principles are often difficult to use in built environments, where the signals do not have sufficient power and where the required localization accuracy is usually greater than that obtainable with these technologies and those based on similar principles, for example for discriminate the position of a person or an object moved by one or more people to whom the mobile device is mechanically coupled within zones, areas, or rooms.

GPS is operationally limited to outdoor environments, where signals from satellites can be received, and therefore cannot be used within the built environment, such as tunnels, homes or offices.

GSM and similar technologies can only be used in the presence of mobile phone coverage. Furthermore, the accuracy obtained is in non-optimal nominal conditions, with error ranges that could make these technologies non-operational.

AGPS, being a combination of the other two aforementioned technologies, suffers from similar problems in principle.

To overcome these limitations, there are location systems specifically designed for applications in a built environment, which use technologies such as Wi-Fi, ZigBee, Bluetooth, Ultra Wide Band (UWB), Radio Frequency IDentification (RFID), or based on principles similar, to determine the position of a person or an object moved by one or more people through an exchange of information between a mobile device mechanically coupled to that person or object and a multiplicity of fixed devices arranged within the built environment, for example in zones, areas or rooms, in which to determine the position of that person or object.

These technologies do not guarantee satisfactory performance in terms of location accuracy in environments hostile to radio transmissions, i.e. environments where there are numerous signal obstacles such as other objects, furniture, walls, or other people. A typical example of an environment hostile to radio transmissions is constituted by shipbuilding areas or areas where there are numerous ferrous objects, such as shipyards. Another typical example of an environment hostile to radio transmissions consists of areas or areas where there are critical machinery for assisting people, such as hospitals.

The limitations of the aforementioned technologies and those based on similar principles are also due to the fact that they mostly use tri-lateration or multi-lateration procedures for calculating the position of a mobile device mechanically coupled to the person or to an object moved by one or more people, whose position is to be determined by exchanging information with a multiplicity of fixed devices with respect to a given reference system, such as satellites, antennas for mobile telephones, or environmental sensors, for which the communication between all the devices that contribute to the localization process must be continuous and reliable according to the state of the art. In fact, the presence of an obstacle between the mobile device and only one of the fixed devices is sufficient for the localization to fail or not have adequate accuracy.

### SUMMARY OF THE INVENTION

The present invention aims at overcoming the disadvantages of the currently known localization systems listed above, and potentially others not mentioned but with similar or derived characteristics, with a system for locating a person or an object moved by one or more people in a built environment, which system comprises at least one sensor for detecting the movement of said person or object in said environment capable, unlike the currently known location systems listed above, to provide data of a differential type over time, and comprising:

at least one transmission unit of differential movement information detected by the sensor mechanically coupled to that person or object;

at least one receiving unit of differential movement information transmitted by this transmission unit;

at least one processing unit comprising a program in which the instructions for realizing a classification of said differential movement information as relating to a voluntary movement action or to an involuntary action, i.e. imposed by events extraneous to the will, are encoded, making said unit of processing (E5) suitable for carrying out the aforementioned classification, where this classification is provided in combination with the recognition of a path within the built environment by comparing differential movement parameters, such as the speed of variation of the position and/or the duration of this variation and/or the speed of variation of the direction and/or the duration of this variation, with models of execution of voluntary movement activities in a plurality of predefined paths in the same built environment.

With “voluntary movement activity” or “voluntary movement” we mean any instance of curve in space that corresponds to a path between two points of interest, to be understood for example as zones, areas, or rooms within an environment built.

The invention therefore provides for an algorithm consisting of a classifier or an expert machine-learning system that exploits an initial database describing movement experiences obtained from empirical statistical measurements of people who move in an environment and who carry out certain daily activities, where said classifier, when applied to a specific person (or moving object) acquires an informative set of conditions of experience of that person which are specifically associated with daily voluntary actions and on the basis of this experience evaluates the measurements coming from said at least one differential sensor to detect whether or not these measurements are compliant with voluntary actions as described by the information set previously built.

The classification of movements as voluntary or not therefore allows the activation of actions conditional on the result of this classification algorithm e.g. the activation of one or more alarms in the event of involuntary movement or the execution of any operational command known to the skilled in the art.

In an advantageous configuration of the system, these parameters and these predefined models can be customized thanks to a learning or calibration phase in which information is collected on the particularities of differential movement of the person or object moved by one or more people that need to be topologically localized., corresponding to conditions of usual behavior in following a certain path, being available a classification algorithm in the form of an inductive or deductive algorithm, such as a computational model based on a neural network or other approximation algorithms capable of performing learning cycles during current usage.

By way of example, the inventors were able to observe how, thanks to the use of inductive algorithms, for example based on neural networks, it is possible to recognize the paths of a person or an object moved by one or more people in an environment constructed from the analysis of only the differential movement data of that person or object, without the need to use references, whether internal to the environment or external, with which to perform tri-lateration or multi-lateration as in known systems. All this with an obvious benefit in terms of simplicity of installation and use of a localization system and cost reduction. Furthermore, all this also for the benefit of a need, which emerges in particular examples of built environments such as hospitals or construction sites, relating to the tracking of unsupervised objects.

To this end, the invention provides, in one embodiment, to equip the person or object moved by one or more people to be located topologically within the built environment with at least one differential motion sensor such as, for example, a accelerometer, a gyroscope, a magnetometer or sensors with similar characteristics, and a device capable of collecting and sending to a processing system, even in batches and in deferred time, the differential movement information so that the system according to the invention is able to estimate the path taken by that person or object, for example by means of inductive algorithms, for example based on neural networks or other approximation algorithms. All this after a learning or calibration phase that allows the system to memorize the movements made by that person or object in following pre-established paths within the built environment in which the topological localization process takes place.

According to another aspect, the invention relates to a method for the topological localization of people or objects moved by one or more people in a built environment, each person or object being associated with a mobile device for the acquisition of differential movement data and transmission of these. data, a data analysis unit being provided in communication with said mobile devices. The method advantageously provides for the following steps:

(a) emission of a signal by the mobile device associated with the person or object moved by one or more people including information linked to differential movement parameters;

(b) reception of this signal by the processing unit;

(c) processing of differential movement information;

(d) recognition of the presence of a voluntary movement activity versus an involuntary movement;

(e) if there is a voluntary movement activity, recognition of a path within the built environment by comparing differential movement parameters, such as for example the speed of variation of the position and/or the duration of this variation and/or the speed of variation of the direction and/or the duration of this variation, with models of execution of voluntary movement activities in a plurality of predefined paths in the same built environment, obtained for example by means of inductive algorithms.

According to an improvement, the step of customizing the execution models of voluntary movement activities is envisaged through a learning or calibration phase in which information is collected on the particularities of differential movement of the person or object moved by one or more corresponding persons to be monitored. under conditions of usual behavior in following the same path, the method providing for the execution of a recognition algorithm in the form of an inductive or deductive algorithm, such as a computational model based on a neural network or other approximation algorithms capable of performing cycles learning during current use.

Further improvements are described later.

### BRIEF DESCRIPTION OF THE DRAWINGS

These and other characteristics and advantages of the present invention will become clearer from the following description of some executive examples illustrated in the attached drawings in which:

FIG. 1 shows four points of interest (PI) labeled PI0, PI1, PI2, PI3, within a map of a built environment with possible paths between them;

FIG. 2 shows the same map in which an intermediate PI (PI1) is highlighted, through which it is necessary to transit in order to carry out both the path from PI0 to PI2, and the reverse path from PI2 to PI0;

FIG. 3 shows an example of a conceptual scheme of the topological localization system object of the present invention, in which relevant functional blocks are highlighted with labels S1, S1′, S2, T3, R4, E5, A10 and A20;

FIG. 4 shows a variant of the diagram in FIG. 3 in which the use of an intermediate interface device, labeled I103, is envisaged, such as for example a smartwatch or similar wearable devices, between sensors and transmission units;

FIG. 5 shows a further communication architecture, in which possible instances of relevant functional modules are highlighted with the labels T3, R4, I103.

### DETAILED DESCRIPTION OF EMBODIMENTS OF THE INVENTION

Before proceeding to the description of the system according to a possible embodiment of the invention, it is appropriate to introduce some definitions.

A “point of interest” (PI) means an area or an area or a room or similar within a built environment in which a person performs an activity that does not cause that person's position to change significantly, or in which there is an object not moved by any person. For simplicity, we can indicate with IPI the set of all points of interest in this environment. Each PI in the IPI can be assigned a consecutive integer identifier starting from zero, for example PI0, PI1, and so on.

With “path” (P) we mean any curve in space that joins two points of interest Ph and PE in IPI, with i and j distinct, and that satisfies the following properties:

(a) compliance with the structural constraints relating to the built environment in which the topological location process takes place, for which, for example, the curve cannot pass through walls or other structural obstacles between zones and/or areas and/or rooms;

(b) piecewise regularity, for which the curve has no cusp points or corner points according to the common definition;

(c) minimality of the length, for which given L the length of the curve and given LO the length of the ideal curve between Ph and PIj, such that the path of this ideal curve satisfies the properties referred to in points a) and b), it must be that the difference between L and LO must be less than an a priori definable threshold, such that the two distances are similar, as it is easy to observe how people tend to use an optimal path to reach a given PI, and in any case to move objects following this optimal path.

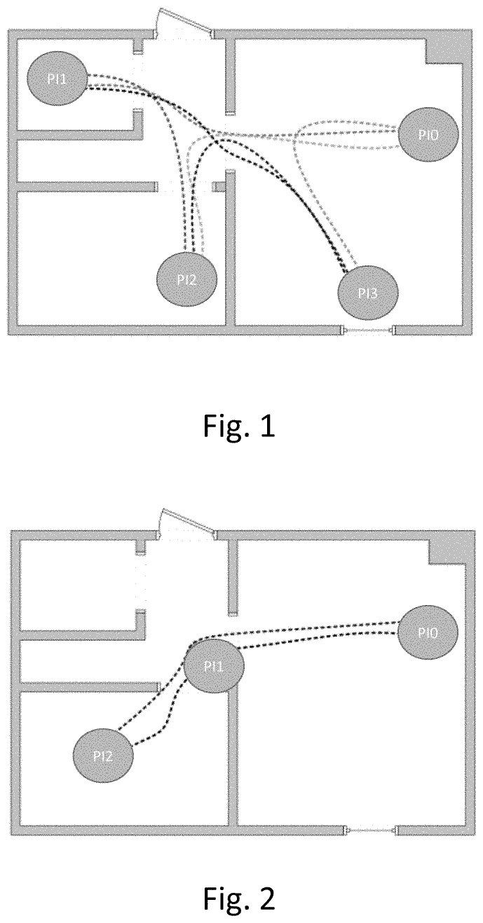

Given two points of interest PIi and PIj in IPI, with i and j distinct, it is possible to indicate with Pij the path that joins the point of interest PIi with the point of interest PE. It is also possible to indicate with IP the set of all paths defined as described among all the IPs in IPI relating to the built environment in which the topological localization process is defined. A possible representation of various points of interest and paths is shown in FIG. 1. Given two points of interest PIi and PE in IPI, with i and j distinct, it is assumed that there is always a path Pij that allows reaching PE starting from Phi.

There could be built environments in which, in order to reach a given point of interest PE in IPI starting from a given point of interest PIi in IPI, with i different from j, it is necessary to pass through another PIk in IPI, with different k from i and j, as highlighted in FIG. 2, and that therefore a path Pij in IP can be advantageously treated as the composition of two paths Pik and Pkj in IP. However, it is useful to distinguish the case in which PIk in IPI is a point of interest in which the person or object moved by one or more people settles for a certain time, or the case in which it corresponds to a simple point of occasional passage, and therefore the said Pij path must advantageously be considered distinct from the union of such Pik and Pkj.

Each P in IP can be assigned a consecutive integer identifier starting from zero, for example P0, P1, and so on. One possible way to do this is to list all the paths, sort them first by source, and then by destination.

Each path P in IP can be associated with at least a corresponding series of one or more differential movement parameters in a suitable sequence, such as the speed of variation of the position and/or the duration of this variation and/or the speed of variation of the direction and/or the duration of this variation.

By “voluntary movement activity” or “voluntary movement” is meant any instance of curve in space that corresponds to a path as defined above.

By “involuntary movement” we mean any instance of a curve in space that begins and ends in the same point of interest Ph in IPI, and which does not deviate significantly from it and in any case such as not to lead to a point of interest PE in IPI, with i and j distinct.

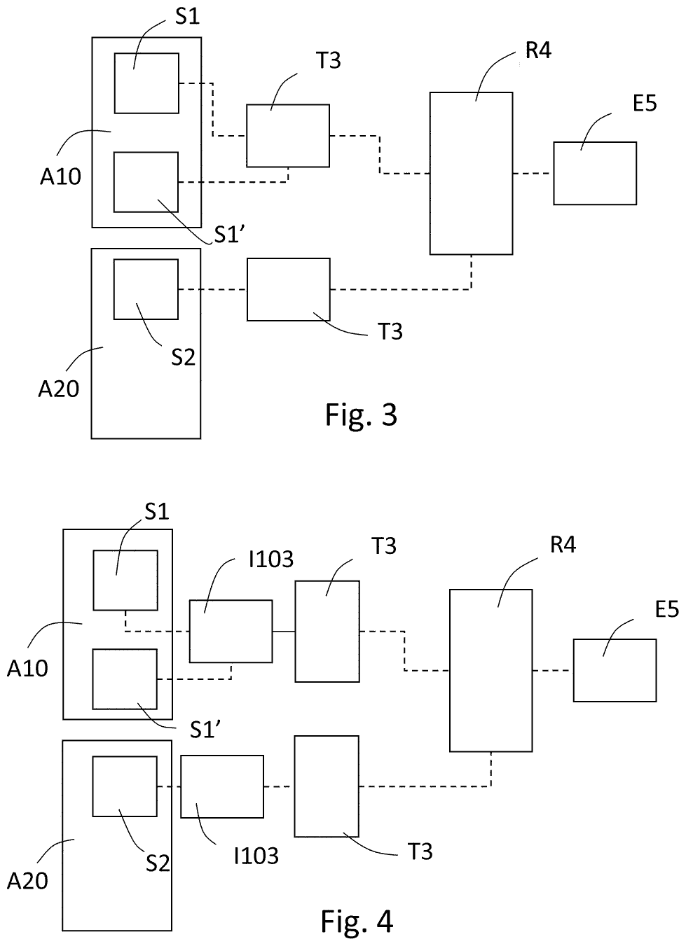

FIG. 3 illustrates an example of a possible scheme of the topological localization system object of the present invention. This system can comprise one or more sensors S1, S1′, S2, for detecting the differential movement of a person or of an object moved by one or more people, one or more units T3 for transmitting the differential movement information detected by the sensors S1, S1′, S2, a receiving unit R4 and a processing unit E5. In the specific example shown in the figure, sensors S1 and S1′ are associated with a first person or first object moved by one or more people A10 while the sensor S2 is associated with a second person or second object moved by one or more people A20. It is obviously possible to consider any number of people or objects moved by one or more people, each associated with any number of sensors. In a common case, the person or object moved by one or more people are the only ones associated with a single sensor.

Sensors of a differential nature can for example be accelerometers, gyroscopes, magnetometers, or sensors based on similar principles. If these sensors are mechanically coupled to a person, these can also be advantageously but optionally supported by sensors of different types such as for example temperature or heartbeat sensors, or other biometric sensors.

FIG. 4 shows a particular configuration of the system according to the present invention specific for a process of topological localization of a person in which there is a smartwatch or similar device I103 for the interface between the sensors S1, S1′, S2, and the smartphone or similar device T3, to facilitate the data collection operation.

In the figures, the connections between the various components are shown in dashed lines to highlight how it can be wireless communications of any kind where appropriate, such as GSM, Wi-Fi, Zigbee, Bluetooth, UWB, RFID. However, this does not exclude that at least part of them are based on physical cables, such as the connection between the R4 receiving unit and the E5 processing unit or between the sensors S1, S1′, S2, and the smartwatch or device. similar I103, and the smartphone or similar device T3, for example via USB, USB-C or HDMI.

An example of how the data can be collected to be processed is now described in the particular case of the configuration of the topological localization system shown in FIG. 4. The data acquisition is carried out through an algorithm that can be partially implemented on the smartwatch or device similar I103 and partly on the smartphone or similar device T3. A remote computer is used to collect information from all the devices used. The aforementioned algorithm can acquire data from sensors such as accelerometers, gyroscopes or magnetometers, or even from other sensors of a differential nature based on similar principles. Data of a different nature can also be acquired, such as those provided by temperature or heart rate sensors, or other biometric sensors. A particularly advantageous version of this algorithm can allow the simultaneous acquisition of data provided by sensors present on different devices, thus allowing to locate different people who can in turn also wear more than one device.

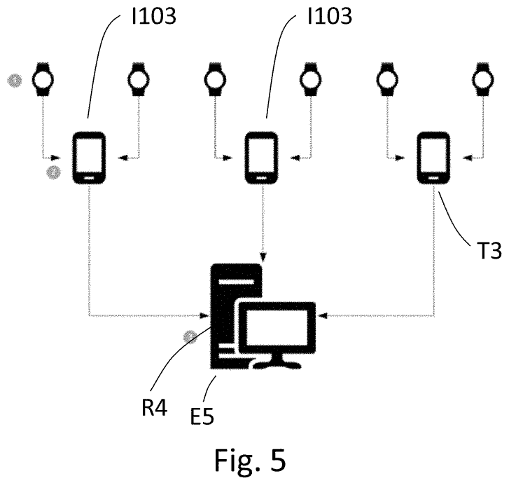

An example of a data communication protocol is now described in the particular case of the configuration shown in FIG. 4. In this example, the smartwatch or similar device I103 does not communicate directly with the R4 receiving unit, but with it via a smartphone or similar device. T3 according to the system architecture shown in FIG. 5. Specifically, this smartwatch or similar device I103 could record data and transmit them to this smartphone or similar device T3 using wireless communication of any kind, such as GSM, Wi-Fi, Zigbee, Bluetooth, UWB, RFID. The smartphone or similar device T3 can communicate the data generated by it and those that can arrive from all other smartwatches or similar devices connected to I103 to the R4 receiving unit. On the remote computer E5 there is an algorithm that, starting from the collected data, is able to:

(a) process the differential movement information received;

(b) recognize the presence of a voluntary movement activity as opposed to an involuntary movement;

(c) if there is a voluntary movement activity, recognize a path within the built environment by comparing differential movement parameters, such as the speed of variation of the position and/or the duration of this variation and/or the speed of variation of the direction and/or the duration of such variation, with models of execution of voluntary movement activities in a plurality of predefined paths in the same built environment, obtained for example by means of inductive algorithms.

In order to recognize the presence of voluntary movement activities, an advantageous implementation of such an algorithm could for example:

consider a priori as involuntary movements all instances of curves in which the speed of variation of the position and/or the duration of this variation and/or the speed of variation of the direction and/or the duration of this variation are lower than a parameter threshold W suitably defined;

consider a priori as involuntary movements all instances of curves shorter than a certain threshold parameter X suitably defined;

distinguish between voluntary movement and involuntary movement activities using data deriving from accelerometers, gyroscopes or magnetometers, or also from other sensors of a differential nature based on similar principles, for example by comparisons with models of performing differential movement activities in a plurality of predefined paths in the built environment, obtained for example by means of inductive algorithms;

in the case of a voluntary movement corresponding to a path Pij in IP, consider this Pij as a unique path and not in relation to any paths of the type Pik and Pkj, where k is distinct from i and j, and that the corresponding PIk in IPI corresponds to a simple occasional crossing point.

This advantageous implementation requires to appropriately define the threshold parameter W, the threshold parameter X, and the choice and/or design of an inductive algorithm for the creation of the models and for the recognition of voluntary versus involuntary movements.

By way of example, the inventors were able to observe how, as regards the threshold parameter W, the choice of an inappropriate value by default could cause the recognition of motion activities that do not exist in reality, even of significant duration, while a value not excessively appropriate could come to exclude voluntary movement activities characterized by reduced speed of variation of the position and/or the duration of this variation and/or the speed of variation of the direction and/or the duration of such variation.

Again by way of example, the inventors were also able to observe how, as regards parameter X, the choice of an inappropriate value by default could cause the separation of a voluntary movement activity into several movement activities in the event that there was a brief interruption of the movement, while the choice of an inappropriate value for excess could cause the recognition as a single activity of voluntary movement of two activities that are actually separate, particularly if the waiting times between an activity and a other were too short.

Again by way of example, the inventors were also able to observe how through the use of inductive algorithms, for example based on neural networks, and in particular recurrent neural networks, it is possible to recognize the paths of a person or a moved object. by one or more people in an environment built from the analysis of only the differential movement data of the person or object themselves provided by a magnetometer mechanically coupled to that person or object, without the need to use references, whether internal to the environment or external, with which to carry out the tri-lateration or multi-lateration as in known systems.

Again by way of example, the inventors were also able to observe how, if inductive algorithms are used, for example based on neural networks, and in particular recurrent neural networks, the result of this algorithm at a certain moment also depends on the result. of this algorithm in the previous states, a property that is interesting because a result, for example a right turn in a path Pij, with distinct i and j, obtained by analyzing the differential movement data, could be identifying a different path, for example Pik, with distinct iek and distinct jek, if a left or a right turn was previously detected.

Again by way of example, the inventors were also able to observe how, if inductive algorithms are used, for example based on neural networks, and in particular recurrent neural networks, the algorithm is able to identify paths with different lengths, given the fact that different paths between different points of interest are typically characterized by different lengths.

Again by way of example, the inventors have also been able to observe how such inductive algorithms can advantageously make use of additional internal or external references to the environment, with which to perform tri-lateration or multi-lateration as in known systems, despite such references are not necessary, to the greater advantage of the accuracy of the topological localization procedure.

The invention claimed is:

1. A system of topological localization of a person or an object moved by one or more people in a built environment, the system comprising:
at least one sensor for detecting a differential movements of the person or object in the built environment;
at least one transmission unit of differential movement information detected by the sensor that is mechanically coupled to the person or object;
at least one receiving unit of the differential movement information transmitted by the transmission unit;
at least one processing unit comprising a program in which instructions for realizing a classification of the differential movement information as relating to a voluntary action of movement or to an involuntary action imposed by events extraneous to will are encoded, making the processing unit adapted to carry out out the classification,
wherein the classification is provided in combination with a recognition of a path within the built environment by comparing differential movement parameters, including one or more of a speed of variation of a position, a duration of a change in the variation of position, a speed of change in direction, or a duration of the change of direction, with models for performing voluntary movement activities in a plurality of predefined paths in the built environment.

2. The system according to claim 1, wherein at least a corresponding set of one or more differential movement parameters are associated with the path in an appropriate sequence, including the speed of variation of the position along the path, or the duration of the variation of the position, the speed of change of direction along the path, or the duration of the change of direction.

3. The system according to claim 1, wherein models of execution of voluntary movement activities are customized due to a training or calibration step in which information is acquired on peculiarities of differential movement of the person or object moved by one or more persons whose position requires to be determined, corresponding to conditions of usual behaviour when moving along a specific path, a classification algorithm being available as inductive or deductive algorithm, including a computational model based on neural network or other approximation algorithms configured to execute training cycles during current use.

4. The system according to claim 1, wherein said at least one differential sensor is coupled to the person or object moved by one or more persons to be topologically located within the built environment, and wherein said at least one differential sensor includes a combination of one or more environmental and/or biometroc sensors selected among accelerometers, gyroscopes, magnetometers, or temperature, heart rate, or other biometric sensors.

5. The system according to claim 1, wherein the occurrence of movements is recognised by comparing a rate of change in position, the duration of the change in position, a rate of change in direction, or the duration of the change in direction from one or more of the sensors with one or more parameters, which include one or more threshold parameters or indicators.

6. The system according to claim 5, wherein a voluntary movement activity is recognized by analyzing data resulting from accelerometers, gyroscopes or magnetometers, or also from other sensors of differential nature based on similar principles by comparisons with models of execution of voluntary movement activities in a plurality of predefined paths in the built environment.

7. The system according to claim 1, wherein data resulting from sensors related to the rate of change in position, the duration of the change in position, the rate of change in direction, or the duration of the change in direction are analysed with inductive algorithms, based on recurrent neural networks, so as to detect voluntary movement activities.

8. The system according to claim 1, wherein the processing unit is configured to represent a topological map of the environment in which it is necessary to perform a topological localization process of a person or object moved by one or more persons, the topological map being made up of a set of points of interest corresponding to zones, areas, or rooms, and the system foreseeing an availability of differential movement information between different points of interest resulting from sensors associated with the person or object.

9. A method of topological localization of persons and objects moved by one or more persons in a built environment, each person or object being associated with at least one differential movement detection sensor of that person or object in said environment, comprising:
(a) detecting differential motion by at least one sensor mechanically coupled to that person or object;
(b) transmitting a signal containing such differential motion information;
(c) receiving the signal emitted by a monitoring unit;
(d) processing the differential movement information received;
(e) recognizing a presence of a voluntary movement activity versus an involuntary movement based on one or more threshold parameters or indicators;
(f) if there is a voluntary movement activity, recognizing a path within the built environment by comparing differential movement parameters, including the speed of variation of position, the duration of the variation in position, the speed of variation of the direction, or the duration of the variation in direction, using models of execution of voluntary movement activities in a plurality of predefined paths in the same built environment.

10. The method according to claim 9, further comprising a step of customizing execution patterns of voluntary movement activities through a learning or calibration phase, in which information is collected on particularities of differential movement of the person or object moved by one or more people whose topological location needs to be determined, corresponding to conditions of usual behavior in following a specific path, a classification algorithm being available as an inductive or deductive algorithm, including a computational model based on a neural network or other approximation configured to perform learning cycles during current use.

11. The method according claim 9, wherein the inductive algorithms use either internal environmental or external references, to perform tri-lateration or multi-lateration as in known systems, to improve accuracy of localization procedure.
